(19) United States
(12) Patent Application Publication
(10) Pub. No.: US 2025/0290857 A1
(43) Pub. Date: Sep. 18, 2025

(54) DEPTH SPECTROSCOPY

(71) Applicant: The Regents of the University of California, Oakland, CA (US)

(72) Inventors: Malcolm Dale Stokes, La Jolla, CA (US); Nicholas Antipa, San Diego, CA (US); Xiang Dai, San Diego, CA (US)

(21) Appl. No.: 19/083,200

(22) Filed: Mar. 18, 2025

Related U.S. Application Data
(60) Provisional application No. 63/566,572, filed on Mar. 18, 2024.

(51) Int. Cl. G01N 21/65

(52) U.S. Cl. CPC G01N 21/65; G01N 2201/0635; G01N 2201/0636

(57) ABSTRACT

Systems and methods for depth-resolving spectroscopy are disclosed. An example system includes an illumination subsystem including a pair of Axicon lenses and a conical mirror; and an encoding subsystem including a diffraction grating and a phase plate optic. The pair of Axicon lenses and the conical mirror collectively produce a depth-spanning beam directed toward a sample volume. The diffraction grating and the phase plate optic collectively produce a two-dimensional spatial optical pattern containing the spectral and depth information of scattered light produced upon interaction of the depth-spanning beam and the sample volume. A depth-resolved Raman spectrum may be reconstructed based on the two-dimensional spatial optical pattern to identify chemical compounds at multiple depths of the sample volume simultaneously.

### CROSS-REFERENCE TO RELATED APPLICATIONS

This application claims priority to the provisional application with Ser. No. 63/566,572, titled “Depth Spectroscopy,” filed Mar. 18, 2024. The entire contents of the above noted provisional application are incorporated by reference as part of the disclosure of this document.

### TECHNICAL FIELD

The present disclosure relates to spectroscopy, and more specifically to depth-resolved spectroscopy.

### BACKGROUND

Chemical films at liquid interfaces influence natural and industrial processes. These films affect the physical properties and stability of the interface, as well as the behavior of dissolved and suspended species in the liquid.

### SUMMARY

An aspect of the present document relates to a system for depth-resolving spectroscopy. In some embodiments, the system includes: an illumination subsystem comprising a pair of Axicon lenses and a conical mirror; and an encoding subsystem comprising a diffraction grating and a phase plate optic. In some embodiments, the pair of Axicon lenses are positioned to receive a source beam generated by a laser source and generate an annular beam directed toward the conical mirror; the conical mirror is positioned to receive the annular beam from the pair of Axicon lenses and produce a depth-spanning beam directed toward a sample volume; the diffraction grating is positioned to receive scattered light produced upon interaction of the depth-spanning beam and the sample volume, and to encode spectral information of the scatter light by dispersing different wavelengths along a first dimension; and the phase plate optic is positioned to receive the spectrally encoded scattered light, encode depth information of the scattered light along a second dimension to produce a two-dimensional spatial optical pattern, and direct the two-dimensional spatial optical pattern toward a light detector to enable generation of a depth-resolved image.

Another aspect of the present document relates to a method for depth-resolving spectroscopy. In some embodiments, the method includes receiving a source beam generated by a laser source; generating a depth-spanning beam based on the source beam; illuminating a sample volume with the depth-spanning beam to produce scattered light; encoding depth information from the scattered light into a spatial optical pattern by passing the scattered light through an encoding subsystem that comprises a phase plate optic; and capturing, with a light detector, the spatial optical pattern, wherein the spatial optical pattern contains depth-encoded information from multiple depths of the sample volume.

A further aspect of the present document relates to a device. In some embodiments, the device includes at least one processor and instructions. The instructions upon execution by the processor cause the processor to perform operations including receiving encoded optical data acquired by a two-dimensional light detector of a depth-resolving spectrometer, wherein the optical data contains both depth and spectral information encoded by a combination of a diffraction grating and a depth coding optic; computationally decoding the encoded optical data to extract the depth information; and generating a depth-resolved spectrum representing chemical composition as a function of depth within a sample volume.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a block diagram of a depth-resolving spectroscopy system, according to some embodiments of the present document.

FIG. 2 illustrates a process for depth-resolving spectroscopy, according to some embodiments of the present document.

FIG. 3 illustrates an optical diagram of a depth-resolving spectroscopy system, according to some embodiments of the present document.

FIG. 4 illustrates spatial optical patterns of different depths of a sample, according to some embodiments of the present disclosure.

FIG. 5 illustrates a simulation corresponding to the spatial optical patterns in FIG. 4, according to some embodiments of the present disclosure.

FIG. 6 illustrates a comparison between the simulated results and ground truth of the results in FIGS. 4 and 5, according to some embodiments of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Chemical films at liquid interfaces influence natural and industrial processes. These films affect the physical properties and stability of the interface, as well as the behavior of dissolved and suspended species in the liquid. As a result, understanding chemical makeup, thickness, and ordering of interfacial chemical layers is desirable for environmental chemistry.

Conventional depth-specific spectrometers rely on confocal techniques and slow scanning. For example, existing scanning confocal Raman spectroscopy allows lateral and axial specificity in sample analysis, done by scanning a single point through a volume. This is a comparably slow process due to the low Raman signal requiring long integration times and the scanning process. Accordingly, conventional Raman spectroscopy systems are ineffective for probing interfaces because they lack axial specificity.

Structured light has been used for probing Raman signals within thick samples, but typically takes a side-view of the sample under test. This precludes using these approaches in-situ where imaging optics cannot be submerged within or intersect the plane of the sample. Standard slit-based methods have been used successfully to probe interfaces of spheres. To use this at an extended interface would also require immersion of the objective.

To address these and other technical problems, the present disclosure provides a method and system for depth-resolving spectroscopy based on a scheme that augments a spectroscopic technique (Raman) through the use of structured light and depth-coding optics combined with computational algorithms. The technology is configured to detect and identify thin films in-situ, thereby allowing noninvasively recording the properties of compounds across interfaces. The technology enables simultaneous multi-depth chemical composition measurements in a single acquisition without mechanical scanning, thereby obviating the need for scanning optics. The scan-free nature of the system enables it to operate orders of magnitude faster than conventional scanning approaches.

The technology disclosed herein uses structured light to simultaneously excite a range of depths across the interface, then uses a coded aperture and dispersive optics to encode the depth-dependent Raman spectrum into a single frame captured using a standard imaging sensor. Computational methods then decode the depth and spectral dimensions. The technology involves a single-shot method that probes an extended interface from an en face position at long working distance. To confine the illumination axially through the interface we will use a Bessel beam as proof of concept, though in principle general structured light patterns could also be explored. By jointly designing the optics and algorithms, this technology provides a device that can probe dynamics occurring around interfaces for rapid, in-situ chemical identification, suitable for portable field measurements.

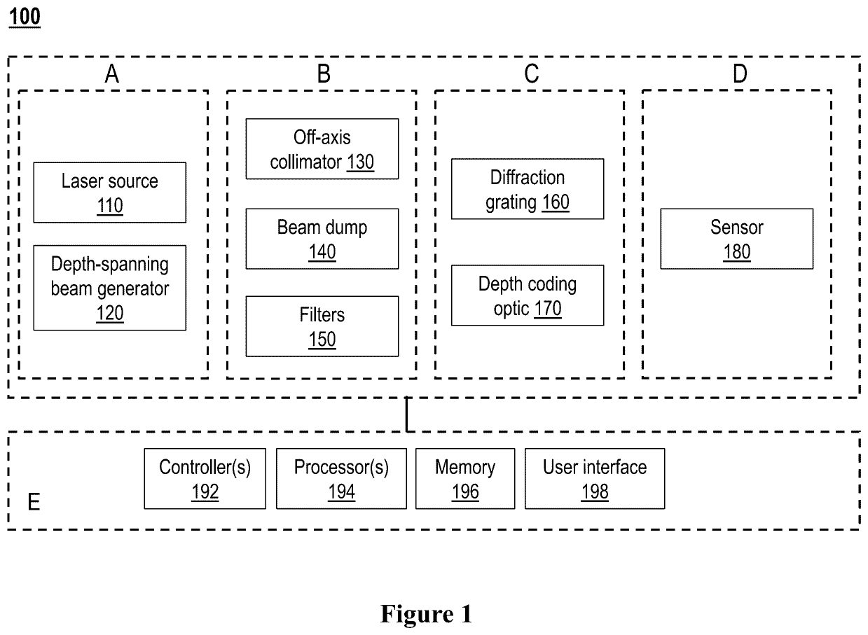

FIG. 1 illustrates a block diagram of a depth-resolving spectroscopy system in accordance with embodiments of the present disclosure. The system 100 comprises subsystems labeled A-E, which together enable single-shot depth-resolving spectroscopy (or referred to as depth spectroscopy for brevity) without mechanical scanning.

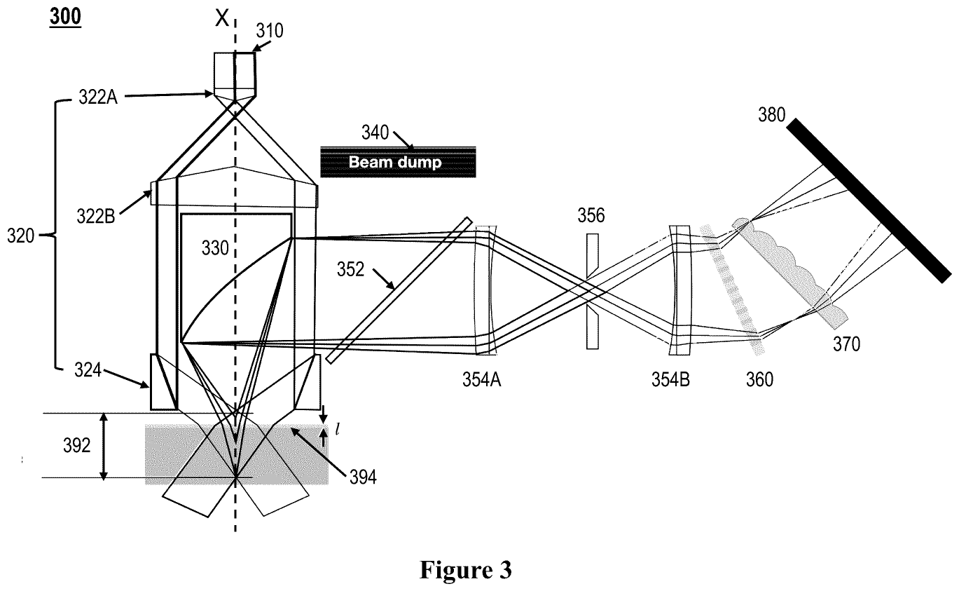

Subsystem A includes an illumination subsystem configured to generate a depth-spanning beam that illuminates a sample volume to produce scattered light. The illumination subsystem includes a laser source 110 and a depth-spanning beam generator 120. The depth-spanning beam generator 120 may include one or more components configured to generate an annular beam (e.g., annular beam generators 322A and 322B in FIG. 3) and one or more components configured to transform the annular beam into a depth-spanning beam (e.g., conical mirror 324 in FIG. 3). For example, the laser source 110 may be a monochromatic laser source. In operation, the laser source 110 generates coherent light that is directed to the depth-spanning beam generator 120. The annular beam generators 322A and 322B form the light into an annular pattern, and the conical mirror 324 transforms this annular pattern into a Bessel beam that serves as the depth-spanning beam. This Bessel beam provides a depth of field of, e.g., at least 10 millimeters and maintains focus across multiple depths within the sample volume.

The depth of field of the depth-spanning beam may be at least 1 millimeter, 2 millimeters, 3 millimeters, 4 millimeters, 5 millimeters, 6 millimeters, 8 millimeters, 10 millimeters, 12 millimeters, 15 millimeters, 16 millimeters, 18 millimeters, 20 millimeters, etc., depending on the specific optical configuration and application requirements. Alternative implementations of the depth-spanning beam generator 120 may include different optical arrangements that can produce Bessel beams or similar non-diffracting beams with extended depth of field, such as axicon lens pairs, spatial light modulators programmed with annular patterns, diffractive optical elements, or specialized phase masks.

Subsystem B includes an optical processing subsystem that manages the optical pathway between the sample volume and subsystem C, the encoding subsystem. The optical processing subsystem performs one or more functions including, e.g., collecting scattered light from the sample volume, processing the collected light to improve signal quality, and directing the processed light to the encoding subsystem for further analysis. For example, the optical processing subsystem includes an off-axis collimator 130 configured to direct the scattered light from the sample volume to the encoding subsystem. As another example, the optical processing subsystem includes a beam dump 140 configured to absorb unwanted light to reduce noise. As a further example, the optical processing subsystem includes one or more filters 150, which may include a wavelength filter (such as a laser line filter configured to isolate Raman scattered light from Rayleigh scattered light) and/or a spatial filter configured to reduce background signals and improve signal-to-noise ratio of the scattered light.

Subsystem C includes an encoding subsystem configured to encode depth information from the scattered light into a spatial optical pattern. The encoding subsystem includes a diffraction grating 160 and a depth coding optic 170. The diffraction grating 160 spatially disperses collected light as a function of wavelength, which may be visualized across columns using false color to illustrate Raman shift.

The depth coding optic 170 encodes depth information into the optical pattern. The depth coding optic 170 may include a phase plate optic. In some embodiments, the depth-coding optic 170 causes light originating from a specific depth to create a unique point spread function (PSF). The phase plate optic creates a PSF that is unique over depth and translation. This may enable recovery of depth and spectrum simultaneously from a single snapshot measurement.

In some embodiments, the depth coding optic 170 and the diffraction grating 160 may be integrated into a single optical element. For example, the diffraction grating 160 may be etched on one surface of the depth coding optic 170 such that light passes through both elements in sequence, with the diffraction grating 160 dispersing the light spectrally before the depth coding optic 170 encodes the depth information. This integration can improve optical efficiency, reduce alignment complexity in the system, and/or reduce the space for these components.

The diffraction grating 160 and the depth-coding optic 170 (e.g., phase or amplitude) work together to encode spectrum and depth into a single exposure (e.g., as illustrated in FIG. 3 which shows simulated point spread functions (PSFs) as a function of depth and spectrum).

Subsystem D includes a light detector, specifically a sensor 180, configured to capture the spatial optical pattern. The sensor 180 may include at least one of a charge-coupled device (CCD), a complementary metal-oxide-semiconductor (CMOS) sensor, an avalanche photodiode array, or a scientific CMOS (sCMOS) sensor. The sensor 180 is configured to capture the spatial optical pattern containing depth-encoded information from multiple depths of the sample volume in a single acquisition without mechanical scanning. The single acquisition may be performed from an en face position relative to the sample volume, by viewing or illuminating the sample (substantially) perpendicular to a surface and into a depth of the sample (e.g., from above) rather than from the side.

Subsystem E includes a control and processing subsystem that provides computational capabilities for operating the depth-resolving spectroscopy system and processing the captured spatial optical patterns. The control and processing subsystem includes at least one controller or control circuit 192 (referred to as controller for brevity) configured to control the operation of the beam generation and optical components. One or more processors 194 are configured to computationally decode the encoded depth information based on the spatial optical pattern captured by the sensor 180 to generate a depth-resolved image. The processor(s) 194 may execute instructions stored in memory 196 to perform computational imaging techniques that convert the encoded depth information into a two-dimensional representation having a first axis representing depth and a second axis representing spectral distribution. In embodiments configured for Raman spectroscopy, the second axis represents Raman shift, and the processor(s) 194 may be further configured to analyze the depth-resolved Raman spectrum to identify chemical compositions of layers of the sample volume at different depths based on characteristic Raman spectral signatures.

In some embodiments, one or more of subsystems A through D, or components of one of the subsystems A through D, may each have its own control unit. For example, the illumination subsystem includes a laser source, a pair of annular beam generators (e.g., Axicon lenses), and a conical mirror, all coaxially arranged along an optical axis (e.g., axis X in FIG. 3). Each component may have its own control unit, enabling precise adjustments to achieve a depth-spanning beam suitable for specific applications. The position of one or more components can be adjusted along the optical axis to modify the beam's depth range. For instance, the spacing between the laser source and one of the annular beam generators may be adjusted by moving either or both components. Similarly, the spacing between the two annular beam generators can be modified by adjusting the position of one or both. Additionally, the spacing between an annular beam generator and the conical mirror may be adjusted by moving either or both components. Furthermore, additional parameters of the conical mirror may be adjustable, such as, the size of its aperture (the central opening), the slope angle of its mirror surface (e.g., in the case of a segmented conical mirror), or the like, or a combination thereof. These adjustments can be managed by one or more control units, enabling the production of a beam with desired parameters (e.g., beam depth) to meet specific application needs.

In some implementations, the controller 192 may provide centralized coordination of these individual control units through a master control architecture that synchronizes operations across the various subsystems. This hierarchical arrangement allows for both autonomous operation of each subsystem and integrated system control. The controller 192 may include specialized software modules for process optimization, adaptive control based on real-time feedback from multiple sensors throughout the system, and predictive maintenance algorithms to enhance system reliability.

The processor(s) 194 may include one or more programmable processors executing one or more computer programs to perform functions by operating on input data and generating output. The processor(s) may also be implemented as special purpose logic circuitry, e.g., an FPGA (field programmable gate array) or an ASIC (application specific integrated circuit). The processor(s) may include both general and special purpose microprocessors, and any one or more processors of any kind of digital computer. The processor(s) 194 may be arranged in a centralized or distributed manner. The processor(s) 194 may be located local with the signal acquisition related subsystems (e.g., one or more of subsystems A through D) or remote.

The control and processing subsystem may include memory 196. For example, the memory 196 may be used in one or more embodiments to house all or some of the instructions needed to implement the functionality of sensor data retrieval, communications with other components of the system 100, control command generation, etc.

In some embodiments, the memory of the control and processing subsystem can include any device, mechanism, or populated data structure used for storing information. In accordance with some embodiments of the present disclosure, memory can encompass, but is not limited to, any type of volatile memory, nonvolatile memory, and dynamic memory. For example, the memory can be random access memory, memory storage devices, optical memory devices, magnetic media, floppy disks, magnetic tapes, hard drives, SIMMs, SDRAM, RDRAM, DDR RAM, SODIMMs, EPROMS, EEPROMs, compact discs, DVDs, and/or the like. In accordance with some embodiments, memory may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information that can be used as memory.

A user interface (UI) 198 allows users to configure system settings, initiate measurements, and view the processed depth-resolved images and analysis results. The UI 198 may include a control panel, where operators can monitor the status of the system 100, input operational parameters, and override automatic controls if needed. This interface may provide manual control over the system and facilitate troubleshooting. The UI 198 may serve as the bridge between a user and the technical processes of the system 100. The UI 198 may include a graphical user interface (GUI).

For example, the UI 198 may feature a dashboard that provides a comprehensive overview of the system 100's current status including, e.g., real-time data on laser power, beam stability, detector temperature, and acquisition status. The UI 198 may have dedicated sections for controlling and adjusting various parameters such as beam intensity, exposure time, depth range of interest, spectral filtering options, and data processing settings. The UI 198 may present data from various sensors to help the user understand the current operating conditions and make informed decisions. The UI 198 may provide access to historical data and logs, detailing past operations, changes made, and any alerts or issues that have arisen. This may assist the user in troubleshooting and understanding the long-term performance of the system 100. The UI 198 may feature an alert system, notifying users of any issues, such as malfunctions, excessive noise levels in spectral data, laser stability problems, or deviations from optimal operating conditions.

The control and processing subsystem may communicate with one or more other components of the system 100 via a wired or a wireless communication path. The control and processing subsystem may include additional communication paths linking a plurality of hardware, software, and/or firmware components operating together. For example, the control and processing subsystem may be implemented by a cloud of computing platforms operating together.

The control and processing subsystem may be connected to or integrated with, via one or more communication paths, a network of sensors, or broader manufacturing management software, allowing for automated operation based on the overall workflow. This integration can optimize the use of the system 100 as part of a larger operation, e.g., automated monitoring of chemical contaminators, oil spills, microplastics, or water quality indicators, etc.

The control and processing subsystem may incorporate one or more safety mechanisms including, e.g., emergency stop functions, overheating alerts, and automatic shutdown protocols in case of malfunctions or potentially harmful conditions in the system 100, e.g., overheat of the laser source 110.

The system 100 may include or communicate with multiple sensors to achieve efficient, safe, and effective functioning. Example sensors temperature sensors configured to monitor the temperature of the laser source 110, etc.

The system 100 is configured to perform depth-resolved Raman spectroscopy from an en face position relative to the sample volume and can be used to monitor chemical contaminants at a liquid interface, such as a liquid-liquid interface or a liquid-air interface, based on the depth-resolved image.

It is understood that the components of FIG. 1, as well as their grouping into different subsystems, are described for illustration purposes and not intended to be limiting. The components may be regrouped, combined, or separated differently in various implementations while maintaining the functional capabilities of the system. Some components may be omitted or added. For example, if components of subsystems C and D may be positioned along the optical pathway of the scattered light from the sample volume without being re-directed (e.g., in the space between the annular beam generator 322B and the conical mirror 324 as illustrated in FIG. 3), the off-axis collimator 330 may be omitted. As another example, additional optical elements such as beam shapers, polarizers, or additional filters may be added to the optical pathway to further condition the light for specific applications. Furthermore, in some embodiments, multiple sensors may be incorporated to simultaneously capture different spectral ranges or to implement reference channels for calibration purposes. The specific configuration may be adapted based on the particular needs of the measurement environment, sample characteristics, and desired spectral or spatial resolution.

As a further example, one or more components of the system 100 may be replaceable to accommodate a broad range of applications. For instance, the system 100 is configured to allow the replacement of annular beam generators with different cone shapes or conical mirrors with varying slope angles, enabling the generation of depth-spanning beams with desired properties. Additionally, filters in the optical processing subsystem may be interchangeable based on the characteristics of the depth-spanning beam, along with other possible modifications.

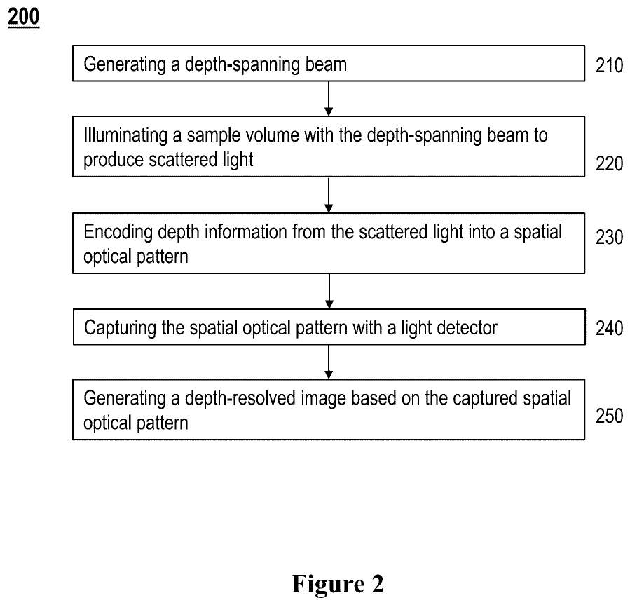

FIG. 2 illustrates a flowchart of a process for depth-resolving spectroscopy in accordance with embodiments of the present disclosure. The process 200 includes operations for acquiring and processing depth-resolved spectral information from a sample volume in a single acquisition. The single acquisition may be performed from an en face position relative to the sample volume, by viewing or illuminating the sample (substantially) perpendicular to a surface and into a depth of the sample (e.g., from above) rather than from the side.

At 210, the process 200 includes generating a depth-spanning beam based on a source beam generated by a laser source. This operation may involve using a monochromatic laser source and creating an annular beam using an annular beam generator of a system for depth-resolving spectroscopy (e.g., system 100). The annular beam may be directed through a conical mirror to generate a Bessel beam as the depth-spanning beam. The Bessel beam provides a depth of field of, e.g., at least 10 millimeters. In some embodiments, the depth of field of the depth-spanning beam may be at least 1 millimeter, 2 millimeters, 3 millimeters, 4 millimeters, 5 millimeters, 6 millimeters, 8 millimeters, 10 millimeters, 12 millimeters, 15 millimeters, 16 millimeters, 18 millimeters, 20 millimeters, etc., depending on the specific optical configuration and application requirements.

At 220, the process 200 includes illuminating a sample volume with the depth-spanning beam to produce scattered light, wherein the depth-spanning beam maintains focus across multiple depths within the sample volume. This illumination may be performed from an en face position relative to the sample volume. The scattered light may include Raman scattered light, which contains chemical composition information about the sample.

At 230, the process 200 includes encoding depth information from the scattered light into a spatial optical pattern. This encoding is performed by passing the scattered light through an encoding subsystem that includes a depth coding optic. The encoding subsystem may further include a diffraction grating, and the encoding may further involve passing the scattered light through the diffraction grating. Prior to reaching the encoding subsystem, the scattered light may be directed from the sample volume using an optical processing subsystem including an off-axis collimator. The scattered light may also be filtered to reduce background signals and improve signal-to-noise ratio. In some embodiments, the system is configured for Raman spectroscopy, a laser line filter may be used to isolate the Raman scattered light from Rayleigh scattered light.

At 240, the process 200 includes capturing the spatial optical pattern with a light detector. The spatial optical pattern contains depth-encoded information from multiple depths of the sample volume. The light detector may be a charge-coupled device (CCD), a complementary metal-oxide-semiconductor (CMOS) sensor, an avalanche photodiode array, or a scientific CMOS (sCMOS) sensor. This capturing is performed in a single acquisition without mechanical scanning. The single acquisition may be performed from an en face position relative to the sample volume.

In some embodiment, the process 200 may further including generating a depth-resolved image based on the captured spatial optical pattern at 250. This operation involves computationally decoding the encoded depth information and may be performed by executing a computational imaging technique that converts the spatial optical pattern into a two-dimensional representation having a first axis representing depth and a second axis representing spectral distribution. When the scattered light includes Raman scattered light, the second axis represents Raman shift, and the depth-resolved image comprises a depth-resolved Raman spectrum.

The process 200 may further include analyzing the depth-resolved image to identify chemical compositions of layers of the sample volume at different depths based on characteristic Raman spectral signatures of chemical compounds in the layers. The process 200 may also include monitoring chemical contaminants at a liquid interface (such as a liquid-liquid interface or a liquid-air interface) based on the depth-resolved image. This monitoring may involve identifying oil spills, microplastics, water quality indicators, or other environmental contaminants.

The process 200 enables rapid, non-invasive chemical analysis of stratified samples and interfaces without requiring mechanical scanning, providing significant advantages over conventional depth-specific spectroscopic techniques.

FIG. 3 illustrates an optical diagram of a depth-resolving spectroscopy system, according to some embodiments of the present document. The system 300 involves computational imaging techniques to decode Raman signal which is created using a laser Bessel beam (structured light) and passed through a coded aperture which encodes the spectrum from each axial depth into a unique pattern on the detector. The system 300 is configured for simultaneous depth-spectral sensing with a dark-field Bessel beam and phase optic. The system 300 allows an examination of a range of axial depths simultaneously using a single capture event (as opposed to acquiring each axial slice individually).

The system 300 includes a laser source 310 configured to generate coherent light that enters the beam generation assembly 320. The beam generation assembly 320 includes a first annular beam generator 322A, a second annular beam generator 322B, and a conical mirror 324. These components work together to create a dark-field Bessel beam that maintains focus across an extended depth of field.

The laser source 310 is configured to generate a source beam and direct it to the annular beam generators 322A and 322B. The source beam may be collimated by a collimator before it impinges on an annual beam generator (e.g., 322A). The annular beam generators 322A and 322B may include a pair of Axicon lenses. In some embodiments, the pair of Axicon lenses includes a first Axicon lens having a first diameter and a second Axicon lens having a second diameter that is larger than the first diameter. The first annular beam generator 322A is positioned coaxially with the second annular beam generator 322B along an optical axis of the source beam (axis X in FIG. 3). The first and second annular beam generators 322A and 322B have their cone tips oriented in opposite directions. The first annular beam generator 322A is positioned closer to the laser source than the second annular beam generator 322B.

The annular beam generators 322A and 322B are positioned to receive the source beam (e.g., a collimated source beam) from the laser source 310. The source beam from the laser source 310 enters the first annular beam generator 322A. The first annular beam generator 322A having a conical surface refracts the source beam outward in a conical pattern, transforming the solid beam into an expanding ring of light. This expanding ring pattern encounters the second annular beam generator 322B, which has its conical surface oriented in the opposite direction than the first annular beam generators 322A. This second annular beam generator 322B further shapes the light pattern, creating a hollow cylindrical beam (annular beam).

The conical mirror 324 is positioned to receive the annular beam. The slanted mirror surface of the conical mirror 324 reflects the hollow cylindrical beam inward at specific angles. This reflection redirects the light rays so they interfere constructively along the optical axis, creating a depth-spanning beam, e.g., a Bessel beam.

One or more parameters of the depth-spanning beam may depend on the structural or operational parameters of the annular beam generators 322A and 322B and the conical mirro 324. Examples of the structural or operational parameters of the annular beam generators 322A and 322B include their dimensions (e.g., diameter), the spacing (or distance) between the annular beam generators 322A and 322B along an optical axis (e.g., the optical axis of a source beam to be processed by the annular beam generators 322A and 322B), the spacing between the laser source 310 and the first annular beam generator 322A, the spacing (or distance) between the second annular beam generator 322B and the conical mirror 324, the cone shape of either the first or second annual beam generator 322A and 322B, or the like, or a combination thereof. Examples of the structural or operational parameters of the conical mirror 324 include the size of its aperture (the central opening), the slope angle of its mirror surface, or the like, or a combination thereof. One or more of these parameters may be adjusted by repositioning a component, replacing a component with one having a desired parameter, or the like, or a combination thereof.

The Bessel beam illuminates a dark-field sample volume 392, which may contain multiple layers or interfaces to be analyzed. The illumination occurs from an en face position (viewing or illuminating the sample volume from (substantially) above the sample, rather than from the side of the sample volume), allowing analysis without disturbing the sample. Under this dark-field illumination approach, light from the beam generation assembly 320 enters the sample from angles or paths outside the collection path, which may reduce background signals and improve detection sensitivity. In some embodiments, a coaxial illumination system, for example a Gaussian beam, may contribute excessive out-of-focus Raman signal. When the Bessel beam illuminates this volume, molecules throughout the entire dark-field sample volume 392 generate Raman scattered light with spectral shifts characteristic of their chemical compositions.

The sample layer 394 with thickness “l” represents a specific region of interest within the dark-field sample volume 392. For example, layer 394 may represent a thin oil film on water, a chemical contaminant layer, microplastics concentrated at a certain depth, or other substances of interest at liquid interfaces. The system's ability to isolate the spectral signature of this specific layer from the surrounding material in the dark-field sample volume 392 enables precise chemical identification of the layer's composition without mechanical scanning or disturbing the sample. This capability is valuable for environmental monitoring applications where detecting thin films or contamination layers at interfaces is desirable.

The scattered light from multiple depths of the sample volume 392 is collected by an off-axis collimator 330 that is positioned to receive and redirect the light through the optical path. The off-axis collimator 330 may be positioned within the aperture of the conical mirror 324 to collect scattered light from the subject volume while reducing or minimizing detection of directly reflected illumination light, thereby reducing background noise and improving signal-to-noise ratio in the detected signal. The redirected scattered light then passes through a laser line filter 352 that isolates Raman scattered light from Rayleigh scattered light. Unwanted or scattered light from the illumination path is directed to a beam dump 340 to reduce noise in the system.

The optical elements 354A and 354B are positioned to receive and focus the scattered light from the off-axis collimator 330 toward the subsequent components. The optical elements 354A and 354B may function as or include focusing mirrors or lenses in the optical pathway. A pinhole 356 serves as a spatial filter to further reduce background signals and improve signal-to-noise ratio. The pinhole 356 may be positioned at or near the focal point created by 354A and 354B.

After filtering, the light passes through a diffraction grating 360 and a depth-coding optic 370. In some embodiments, the depth-coding optic 370 includes a phase plate optic. The diffraction grating 360 is positioned to receive and disperses the light by wavelength, spatially separating different wavelengths along a first dimension of the optical path, thereby encoding spectral information. This creates a spatially encoded spectral pattern that corresponds to the sample's chemical composition through characteristic Raman shifts. The depth-coding optic 370 is positioned to receive and encodes depth information into the scattered light from the diffraction grating 360, along a second dimension (e.g., orthogonal to the first dimension). As a result, the resultant optical pattern contains both spectral and depth information, mapped across two spatial dimensions. The diffraction grating 360 and the depth-coding optic 370 may be aligned to preserve this spatial encoding, enabling computational reconstruction and allowing the system to distinguish signals from different depths within the sample volume.

The sensor 380 is positioned to capture the spatially encoded light. The detected spatial optical pattern contains both depth and spectral information acquired in a single acquisition without mechanical scanning.

This optical configuration enables the system to illuminate multiple depths simultaneously and encode the depth-dependent spectral information into a single image frame. The dark-field Bessel beam approach prevents excessive out-of-focus emission from contributing background light to the measurements, while the combination of the diffraction grating and depth-coding optic creates point spread functions that are unique over depth and wavelength, enabling recovery of both depth and spectrum simultaneously from a single snapshot measurement.

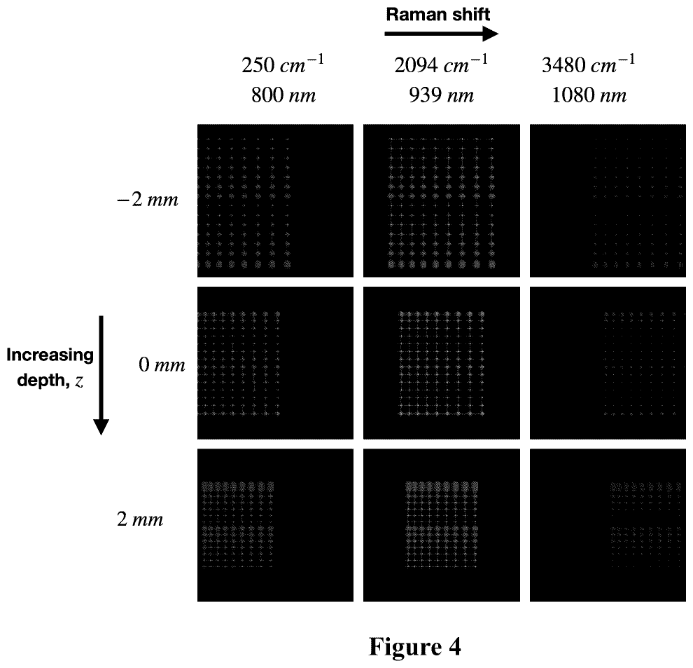

FIG. 4 illustrates spatial optical patterns of different depths of a sample, according to some embodiments of the present disclosure. Specifically, FIG. 4 illustrates how the spatial optical patterns vary based on both the depth position and Raman shift (wavelength). The figure is organized as a matrix where the columns represent different Raman shifts: 250 cm⁻¹ (800 nm) (left column-blue), 2094 cm⁻¹ (939 nm) (middle column-yellow), and 3480 cm⁻¹ (1080 nm) (right column-red), moving from left to right. The rows represent different depths in the sample: −2 mm (above the interface), 0 mm (at the interface), and 2 mm (below the interface), moving from top to bottom.

Each image within the matrix shows a unique point spread function (PSF) pattern created by the combination of the diffraction grating and depth coding optic. The patterns change in color across columns (left column-blue, middle column-yellow, right column-red) corresponding to different wavelengths or Raman shifts, while also changing in size and structure down the rows as depth increases. This results in each position in the depth-wavelength space having a unique spatial pattern.

These distinct patterns are what enable the system to distinguish signals from different depths and wavelengths in a single acquisition. When light from multiple depths and with multiple Raman shifts reaches the sensor simultaneously, these unique encoding patterns allow the computational algorithms to separate and identify the origins of each signal component. This figure effectively demonstrates how the depth coding optic creates unique spatial encodings for light originating from different depths, while the diffraction grating separates different wavelengths, together creating a comprehensive spatial encoding of both depth and spectral information.

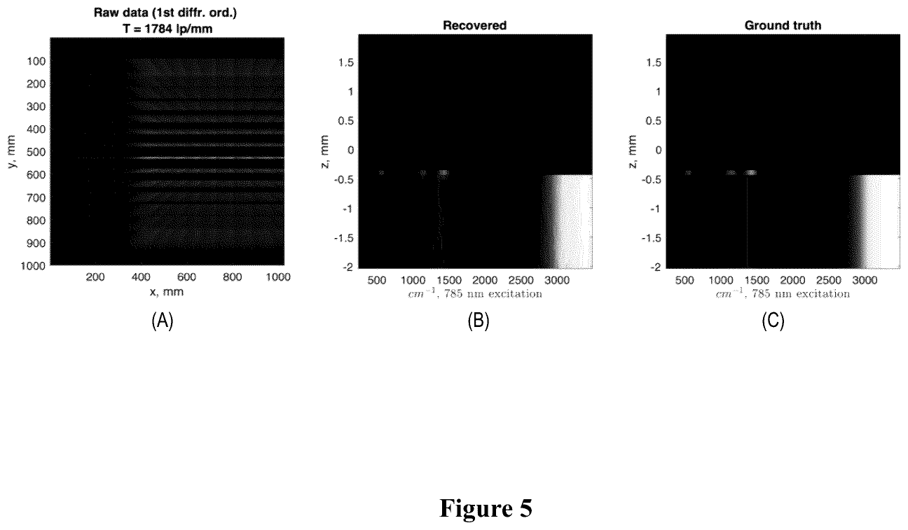

FIG. 5 shows a simulation corresponding to the spatial optical patterns in FIG. 4, according to some embodiments of the present disclosure. On the left is a simulation of raw data from our proposed technique with Poisson noise added at a peak photon count of 5,000 photons. The measurement is a linear combination of PSFs like those in FIG. 4. Middle: the spectrum computed from the raw data using conventional inverse problem methods (Fast Iterative Shrinkage Thresholding Algorithm). Right: the ground truth spectrum. Note that the layer thickness, position, and Raman spectrum are all well recovered from a single exposure.

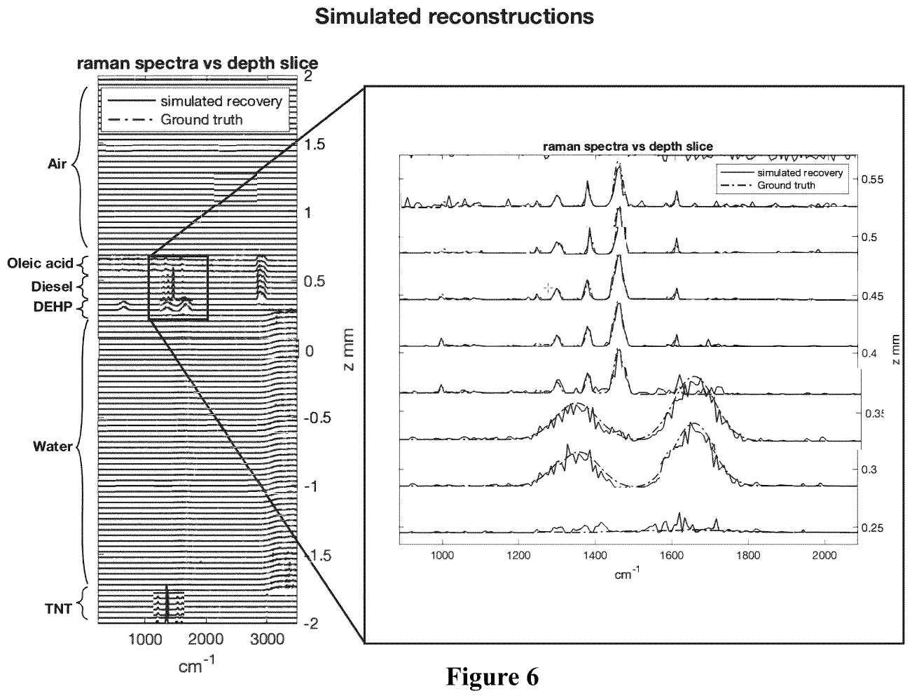

FIG. 6 illustrates a comparison between the simulated results and ground truth of the results in FIGS. 4 and 5, according to some embodiments of the present disclosure. FIG. 6 illustrates simulated reconstruction of a stratified sample having layers including air, oleic acid, diesel, DEHP, water, and TNT, respectively. The recovered spectra are drawn over the ground truth (noise free). This assumes 5,000 photons collected from the brightest object point. As illustrated in FIG. 6, the layers are well separated in the reconstruction. The resolution may be dependent upon the illumination profile, desired depth range and spectral range, as well as the overall aperture size.

The technology combines spatially confined illumination with a grating and depth coding optic, to provide a scan-free, single-shot method of noninvasively recording Raman spectra as a function of depth within a sample volume. The specific design is an example to illustrate the broader method. The specific design may be adapted to provide a desirable combination of the signal strength, depth and spectral ranges of interest, and spatio-spectral resolution based on the needs of different applications. The technology may be used in rapid depth-dependent chemical fingerprinting for immediate chemical discrimination in the environment. As an example, there are multiple toxic contaminants and threat agents (e.g., dioxins, polycyclic aromatic hydrocarbons (PAHs), perfluoroalkoxy or polyfluoroalkyl substances (PFAs), volatile organic compounds (VOCs), heavy metals, particulates) that may become present in the environment (soils, surface and groundwater) near burn pits or sites of waste disposal. Hydrophobic compounds like dioxins, PFAs etc., preferentially distribute along air-liquid interfaces where they can be easily volatilized or mixed into terrestrial sediments and the interfaces themselves may act as substrates for secondary chemical reactions. The early detection and tracking of target compounds like these is currently difficult because it requires the collection and isolation of sample components in a laboratory and cannot easily be performed directly in situ. The technology as disclosed herein may be used to achieve rapid, non-invasive detection thereof in situ.

The following examples are illustrative of several embodiments of the present technology:

Solution 1. A system for depth-resolving spectroscopy, comprising: an illumination subsystem comprising a pair of Axicon lenses and a conical mirror; and an encoding subsystem comprising a diffraction grating and a phase plate optic. In some embodiments, the pair of Axicon lenses are positioned to receive a source beam generated by a laser source and generate an annular beam directed toward the conical mirror; the conical mirror is positioned to receive the annular beam from the pair of Axicon lenses and produce a depth-spanning beam directed toward a sample volume; the diffraction grating is positioned to receive scattered light produced upon interaction of the depth-spanning beam and the sample volume, and to encode spectral information of the scatter light by dispersing different wavelengths along a first dimension; and the phase plate optic is positioned to receive the spectrally encoded scattered light, encode depth information of the scattered light along a second dimension to produce a two-dimensional spatial optical pattern, and direct the two-dimensional spatial optical pattern toward a light detector to enable generation of a depth-resolved image.

Solution 2. The system of any one or more of Solution 1 or any other solutions disclosed herein, wherein the pair of Axicon lenses comprises a first Axicon lens having a first diameter and a second Axicon lens having a second diameter that is larger than the first diameter, the first Axicon lens is positioned coaxially with and facing the second Axicon lens along an optical axis of the source beam, with the first and second Axicon lenses having their cone tips oriented in opposite directions, and the first Axicon lens is positioned closer to the laser source than the second Axicon lens.

Solution 3. The system of any one or more of Solution 1 or any other solutions disclosed herein, wherein the depth-spanning beam provides a depth of field of, e.g., at least 3 to 5 millimeters.

Solution 4. The system of any one or more of Solution 1 or any other solutions disclosed herein, wherein the laser source is a monochromatic laser source.

Solution 5. The system of any one or more of Solution 1 or any other solutions disclosed herein, wherein the system is configured to detect Raman scattered light from the sample volume.

Solution 6. The system of any one or more of Solution 5 or any other solutions disclosed herein, wherein the spatial optical pattern comprises Raman spectral information along with the depth information, and wherein the depth-resolved image comprises a depth-resolved Raman spectrum.

Solution 7. The system of any one or more of Solution 6 or any other solutions disclosed herein, further comprising a processor configured to analyze the spatial optical pattern or the depth-resolved Raman spectrum to identify chemical compositions of layers of the sample volume at different depths based on characteristic Raman spectral signatures of chemical compounds in the layers.

Solution 8. The system of any one or more of Solution 1 or any other solutions disclosed herein, wherein the system is configured to perform depth-resolved Raman spectroscopy from an en face position relative to the sample volume.

Solution 9. The system of any one or more of Solution 1 or any other solutions disclosed herein, wherein either the laser source or the light detector, or both, are part of the system.

Solution 10. The system of any one or more of Solution 1 or any other solutions disclosed herein, wherein the depth coding optic and the diffraction grating are integrated into a single optical element.

Solution 11. The system of any one or more of Solution 1 or any other solutions disclosed herein, wherein the system is configured to capture the spatial optical pattern for generation of the depth-resolved image in a single acquisition without mechanical scanning.

Solution 12. The system of any one or more of Solution 1 or any other solutions disclosed herein, further comprising an optical processing subsystem configured to direct the scattered light from the sample volume to the encoding subsystem.

Solution 13. The system of any one or more of Solution 12 or any other solutions disclosed herein, wherein the optical processing subsystem comprises an off-axis collimator positioned to receive and direct the scattered light from the sample volume to the encoding subsystem.

Solution 14. The system of any one or more of Solution 12 or any other solutions disclosed herein, wherein the optical processing subsystem comprises at least one of a wavelength filter or a spatial filter configured to reduce background signals and improve signal-to-noise ratio of the scattered light.

Solution 15. The system of any one or more of Solution 14 or any other solutions disclosed herein, wherein the wavelength filter comprises a laser line filter configured to isolate Raman scattered light from Rayleigh scattered light.

Solution 16. The system of any one or more of Solution 1 or any other solutions disclosed herein, further comprising a processor configured to computationally decode the encoded depth information based on the spatial optical pattern to generate the depth-resolved image.

Solution 17. The system of any one or more of Solution 16 or any other solutions disclosed herein, wherein the processor is configured to execute instructions to perform a computational imaging technique that converts the spatial optical pattern into a two-dimensional representation having a first axis representing depth and a second axis representing Raman shift.

Solution 18. The system of any one or more of Solution 1 or any other solutions disclosed herein, wherein the system is configured to monitor chemical contaminants at a liquid interface based on the spatial optical pattern.

Solution 19. The method any one or more of Solution 18 or any other solutions disclosed herein, wherein the liquid interface is a liquid-liquid interface or a liquid-air interface.

Solution 20. The system of any one or more of Solution 1 or any other solutions disclosed herein, wherein the light detector comprises at least one of a charge-coupled device (CCD), a complementary metal-oxide-semiconductor (CMOS) sensor, an avalanche photodiode array, or a scientific CMOS (sCMOS) sensor.

Solution 21. A method for depth-resolving spectroscopy, comprising:
receiving a source beam generated by a laser source;
generating a depth-spanning beam based on the source beam;
illuminating a sample volume with the depth-spanning beam to produce scattered light;
encoding depth information from the scattered light into a spatial optical pattern by passing the scattered light through an encoding subsystem that comprises a depth coding optic;
capturing, with a light detector, the spatial optical pattern, wherein the spatial optical pattern contains depth-encoded information from multiple depths of the sample volume.

Solution 22. The method of any one or more of Solution 21 or any other solutions disclosed herein, wherein generating the depth-spanning beam comprises: creating an annular beam using at least one annular beam generator; and directing the annular beam through a conical mirror to generate a Bessel beam as the depth-spanning beam.

Solution 23. The method of any one or more of Solution 21 or any other solutions disclosed herein, wherein illuminating the sample volume comprises illuminating the sample volume from an en face position relative to the sample volume.

Solution 24. The method of any one or more of Solution 21 or any other solutions disclosed herein, wherein the encoding subsystem further comprises a diffraction grating, and the method comprises passing the scattered light through the diffraction grating.

Solution 25. The method of any one or more of Solution 21 or any other solutions disclosed herein, comprising: directing the scattered light from the sample volume toward an off-axis collimator positioned along an optical pathway between the sample volume and the encoding subsystem.

Solution 26. The method of any one or more of Solution 25 or any other solutions disclosed herein, further comprising: filtering the scattered light to reduce background signals and improve signal-to-noise ratio.

Solution 27. The method of any one or more of Solution 21 or any other solutions disclosed herein, wherein the scattered light comprises Raman scattered light, and wherein the spatial optical pattern comprises Raman spectral information along with the depth information.

Solution 28. The method of any one or more of Solution 27 or any other solutions disclosed herein, further comprising: analyzing the spatial optical pattern or the depth-resolved image to identify chemical compositions of layers of the sample volume at different depths based on characteristic Raman spectral signatures of chemical compounds in the layers.

Solution 29. The method of any one or more of Solution 27 or any other solutions disclosed herein, comprising: isolating the Raman scattered light from Rayleigh scattered light using a laser line filter.

Solution 30. The method of any one or more of Solution 21 or any other solutions disclosed herein, comprising: generating, based on the captured spatial optical pattern, a depth-resolved image representing the depth-encoded information.

Solution 31. The method of any one or more of Solution 31 or any other solutions disclosed herein, wherein generating the depth-resolved image comprises: executing a computational imaging technique that converts the spatial optical pattern into a two-dimensional representation having a first axis representing depth and a second axis representing spectral distribution.

Solution 32. The method of any one or more of Solution 31 or any other solutions disclosed herein, wherein the second axis represents Raman shift.

Solution 33. The method of any one or more of Solution 21 or any other solutions disclosed herein, wherein capturing the spatial optical pattern comprises capturing the spatial optical pattern in a single acquisition without mechanical scanning.

Solution 34. The method of any one or more of Solution 21 or any other solutions disclosed herein, wherein the depth-spanning beam provides a depth of field of at least 10 millimeters.

Solution 35. The method of any one or more of Solution 21 or any other solutions disclosed herein, further comprising: monitoring chemical contaminants at a liquid interface based on the depth-resolved image or the spatial optical pattern.

Solution 36. The method any one or more of Solution 35 or any other solutions disclosed herein, wherein the liquid interface is a liquid-liquid interface or a liquid-air interface.

Solution 37. The method of any one or more of Solution 36 or any other solutions disclosed herein, wherein monitoring chemical contaminants comprises identifying at least one of oil spills, microplastics, or water quality indicators.

Solution 38. A device comprising at least one processor and instructions, wherein the instructions upon execution by the at least one processor, cause the at least one processor to perform operations including:
receiving encoded optical data acquired by a two-dimensional light detector of a depth-resolving spectrometer, wherein the optical data contains both depth and spectral information encoded by a combination of a diffraction grating and a depth coding optic;
computationally decoding the encoded optical data to extract the depth information; and
generating a depth-resolved spectrum representing chemical composition as a function of depth within a sample volume.

Solution 39. The device of any one or more of Solution 38 or any other solutions disclosed herein, wherein the encoded optical data contains Raman spectral information, and wherein generating the depth-resolved spectrum comprises generating a depth-resolved Raman spectrum.

Solution 40. The device of any one or more of Solution 39 or any other solutions disclosed herein, wherein the instructions further cause the at least one processor to identify chemical compounds based on their characteristic Raman spectral signatures detected at different depths in the sample volume.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A system for depth-resolving spectroscopy, comprising:
an illumination subsystem comprising a pair of Axicon lenses and a conical mirror; and
an encoding subsystem comprising a diffraction grating and a phase plate optic, wherein:
the pair of Axicon lenses are positioned to receive a source beam generated by a laser source and generate an annular beam directed toward the conical mirror;
the conical mirror is positioned to receive the annular beam from the pair of Axicon lenses and produce a depth-spanning beam directed toward a sample volume;
the diffraction grating is positioned to receive scattered light produced upon interaction of the depth-spanning beam and the sample volume, and to encode spectral information of the scatter light by dispersing different wavelengths along a first dimension; and
the phase plate optic is positioned to receive the spectrally encoded scattered light, encode depth information of the scattered light along a second dimension to produce a two-dimensional spatial optical pattern, and direct the two-dimensional spatial optical pattern toward a light detector to enable generation of a depth-resolved image.

2. The system of claim 1, wherein:
the pair of Axicon lenses comprises a first Axicon lens having a first diameter and a second Axicon lens having a second diameter that is larger than the first diameter,
the first Axicon lens is positioned coaxially with and facing the second Axicon lens along an optical axis of the source beam, with the first and second Axicon lenses having their cone tips oriented in opposite directions, and
the first Axicon lens is positioned closer to the laser source than the second Axicon lens.

3. The system of claim 1, wherein the depth-spanning beam comprises a Bessel beam.

4. The system of claim 1, wherein:
the system is configured to detect Raman scattered light from the sample volume;
the spatial optical pattern comprises Raman spectral information along with the depth information; and
the depth-resolved image comprises a depth-resolved Raman spectrum.

5. The system of claim 4, comprising a processor configured to analyze the spatial optical pattern to identify chemical compositions of layers of the sample volume at different depths based on characteristic Raman spectral signatures of chemical compounds in the layers.

6. The system of claim 1, wherein the system is configured to perform depth-resolved Raman spectroscopy from an en face position relative to the sample volume.

7. The system of claim 1, wherein the system is configured to capture the spatial optical pattern for generation of the depth-resolved image in a single acquisition without mechanical scanning.

8. The system of claim 1, further comprising an optical processing subsystem comprising at least one of: an off-axis collimator, a wavelength filter, or a spatial filter configured to reduce background signals and improve signal-to-noise ratio of the scattered light, wherein at least a portion of the optical processing subsystem is positioned along an optical pathway between the sample volume and the encoding subsystem.

9. The system of claim 1, further comprising a processor configured to computationally decode the encoded depth information based on the spatial optical pattern to generate the depth-resolved image.

10. The system of claim 1, wherein the light detector comprises at least one of a charge-coupled device (CCD), a complementary metal-oxide-semiconductor (CMOS) sensor, an avalanche photodiode array, or a scientific CMOS (sCMOS) sensor.

11. A method for depth-resolving spectroscopy, comprising:
receiving a source beam generated by a laser source;
generating a depth-spanning beam based on the source beam;
illuminating a sample volume with the depth-spanning beam to produce scattered light;
encoding depth information from the scattered light into a spatial optical pattern by passing the scattered light through an encoding subsystem that comprises a phase plate optic;
capturing, with a light detector, the spatial optical pattern, wherein the spatial optical pattern contains depth-encoded information from multiple depths of the sample volume.

12. The method of claim 11, wherein generating the depth-spanning beam comprises:
creating an annular beam using a pair of Axicon lenses; and
directing the annular beam through a conical mirror to generate a Bessel beam as the depth-spanning beam.

13. The method of claim 11, wherein illuminating the sample volume comprises illuminating the sample volume from an en face position relative to the sample volume.

14. The method of claim 11, wherein the encoding subsystem comprises a diffraction grating, and the method comprises passing the scattered light through the diffraction grating.

15. The method of claim 11, comprising performing at least one of:
directing the scattered light from the sample volume toward an off-axis collimator positioned along an optical pathway between the sample volume and the encoding subsystem, or
filtering the scattered light to reduce background signals and improve signal-to-noise ratio.

16. The method of claim 11, wherein:
the scattered light comprises Raman scattered light;
the spatial optical pattern comprises Raman spectral information along with the depth information; and
the method further comprises analyzing the spatial optical pattern to identify chemical compositions of layers of the sample volume at different depths based on characteristic Raman spectral signatures of chemical compounds in the layers.

17. The method of claim 11, comprising:
generating, based on the captured spatial optical pattern, a depth-resolved image representing the depth-encoded information.

18. The method of claim 11, wherein capturing the spatial optical pattern comprises capturing the spatial optical pattern in a single acquisition without mechanical scanning.

19. The method of claim 11, further comprising:
monitoring chemical contaminants at a liquid interface based on the spatial optical pattern.

20. A device comprising:
at least one processor and instructions, wherein the instructions upon execution by the at least one processor cause the at least one processor to perform operations including:
receiving encoded optical data acquired by a two-dimensional light detector of a depth-resolving spectrometer, wherein the optical data contains both depth and spectral information encoded by a combination of a diffraction grating and a depth coding optic;
computationally decoding the encoded optical data to extract the depth information; and
generating a depth-resolved spectrum representing chemical composition as a function of depth within a sample volume.
